(19) United States
(12) Patent Application Publication
(10) Pub. No.: US 2025/0308745 A1
(43) Pub. Date: Oct. 2, 2025

(54) INDUCTOR ARRAY AND INDUCTOR BUILT-IN SUBSTRATE INCLUDING THE SAME

(71) Applicant: TAIYO YUDEN CO., LTD., Tokyo (JP)

(72) Inventors: Takayuki ARAI, Tokyo (JP); Tomoo KASHIWA, Tokyo (JP)

(21) Appl. No.: 19/091,186

(22) Filed: Mar. 26, 2025

(30) Foreign Application Priority Data
Mar. 27, 2024 (JP) 2024-050657

(51) Int. Cl. H01F 27/02; H01F 27/29; H01F 27/32; H01F 41/00

(52) U.S. Cl. CPC H01F 27/022; H01F 27/29; H01F 27/327; H01F 41/005

(57) ABSTRACT

An inductor array includes: a base body containing a plurality of metal magnetic particles; first and second internal conductors provided inside the base body; a first external electrode connected to one end of the first internal conductor; a second external electrode connected to the other end of the first internal conductor; a third external electrode connected to one end of the second internal conductor; a fourth external electrode connected to the other end of the second internal conductor. The base body has a first surface, a second surface connected to this first surface via a first ridge portion, and a third surface connected to the first surface via a second ridge portion. The first to fourth external electrodes are provided on the first surface of the base body. The first to fourth external electrodes on the first surface are all spaced apart from both the first and second ridge portions.

### CROSS-REFERENCE TO RELATED APPLICATIONS

This application is based on and claims the benefit of priority from Japanese Patent Application Serial No. 2024-050657 (filed on Mar. 27, 2024), the contents of which are hereby incorporated by reference in its entirety.

### TECHNICAL FIELD

The present disclosure relates to an inductor array and an inductor built-in substrate having the inductor array.

### BACKGROUND

An inductor array including a plurality of inductors has been known. A plurality of inductors are packaged in a single chip to form such an inductor array. The inductor array includes, for example, a base body, a plurality of internal conductors provided in the base body and insulated from each other in the base body, and a plurality of external electrodes. The plurality of external electrodes connected to the plurality of internal conductors at respective ends thereof. Examples of the conventional inductor array are disclosed, for example, in Japanese Patent Application Publication No. 2016-006830 and Japanese Patent Application Publication No. 2019-153649.

In the inductor array, multiple inductor elements are provided in a single chip, so that such multiple inductor elements can be mounted on a substrate at high density. On the other hand, the close spacing between the inductor elements tends to degrade the insulation reliability between the elements. In particular, because the external electrode connected to an end of one inductor element is disposed adjacent to the external electrode connected to an end of another inductor element at a short distance, a short circuit is likely to occur between such adjacent external electrodes.

As the base body of the inductor array, a soft magnetic base body containing a large number of metal magnetic particles made of a soft magnetic material is used. Since the soft magnetic base body is less prone to magnetic saturation than a magnetic base body made of ferrite, the soft magnetic base body is suitable, in particular, for large-current circuits. In the soft magnetic base body, surfaces of the metal magnetic particles are covered with insulating films to ensure insulation between the internal conductors and between the external electrodes. Since the soft magnetic base body has lower insulation than the base body made of ferrite, the inductor array with the soft magnetic base body is prone to short circuits between the external electrodes.

### SUMMARY

One object of the present disclosure is to provide an inductor array that can more reliably ensure insulation between the external electrodes. Other objects of the present disclosure will be made apparent through the entire description in the specification. The inventions disclosed herein may also address drawbacks other than that grasped from the above description. The various inventions disclosed herein may be collectively referred to as “the invention”.

An inductor array according to one aspect of the disclosure includes: a base body; a first internal conductor provided inside the base body; a second internal conductor provided inside the base body; a first external electrode connected to one end of the first internal conductor; a second external electrode connected to the other end of the first internal conductor; a third external electrode connected to one end of the second internal conductor; and a fourth external electrode connected to the other end of the second internal conductor. The base body has a first surface, a second surface connected to this first surface via a first ridge portion, and a third surface connected to the first surface via a second ridge portion. The first external electrode, second external electrode, third external electrode, and fourth external electrode are provided on the first surface of the base body.

In one aspect, the first external electrode, the second external electrode, the third external electrode, and the fourth external electrode on the first surface are all spaced apart from both the first ridge portion and the second ridge portion.

### Advantageous Effects

According to one aspect of the disclosure, insulation between the external electrodes can be more reliably secured in the array inductor.

### BRIEF DESCRIPTION OF THE DRAWINGS

FIG. 1 is a schematic perspective view of an inductor array 1 according to one embodiment of the present disclosure.

FIG. 2 is a plan view of the inductor array 1 of FIG. 1.

FIG. 3 is a schematic sectional view of the inductor array 1 of FIG. 1 along the I-I line to show an LT plane.

FIG. 4 is a schematic plan view of an inductor array 101 according to another embodiment of the disclosure.

FIG. 5 schematically shows an LT plane of the inductor array 101 of FIG. 4.

FIG. 6 schematically shows an LT plane of an inductor array 201 according to yet another embodiment of the disclosure.

FIG. 7 schematically shows an LT plane of an inductor array 301 according to still yet another embodiment of the disclosure.

FIG. 8 schematically shows an LT plane of an inductor array 401 according to yet another embodiment of the disclosure.

FIG. 9A schematically illustrates a part of a manufacturing process of a substrate with a built-in inductor according to one embodiment.

FIG. 9B schematically illustrates a part of the manufacturing process of the substrate with the built-in inductor according to the embodiment.

FIG. 9C schematically illustrates a part of the manufacturing process of the substrate with the built-in inductor according to the embodiment.

FIG. 9D schematically illustrates a part of the manufacturing process of the substrate with the built-in inductor according to the embodiment.

FIG. 9E schematically illustrates a part of the manufacturing process of the substrate with the built-in inductor according to the embodiment.

FIG. 9F schematically illustrates a part of the manufacturing process of the substrate with the built-in inductor according to the embodiment.

### DESCRIPTION OF THE EMBODIMENTS

Various embodiments of the disclosure will be described hereinafter with reference to the appended drawings. Throughout the drawings, the same components are denoted by the same or like reference numerals. For convenience of explanation, the drawings are not necessarily drawn to scale. The following embodiments of the disclosure do not limit the scope of the claims. The elements included in the following embodiments are not necessarily essential to solve the problem addressed by the disclosure.

### 1. First Embodiment (Inductor Array 1)

### 1-1. Basic Structure of Inductor Array 1

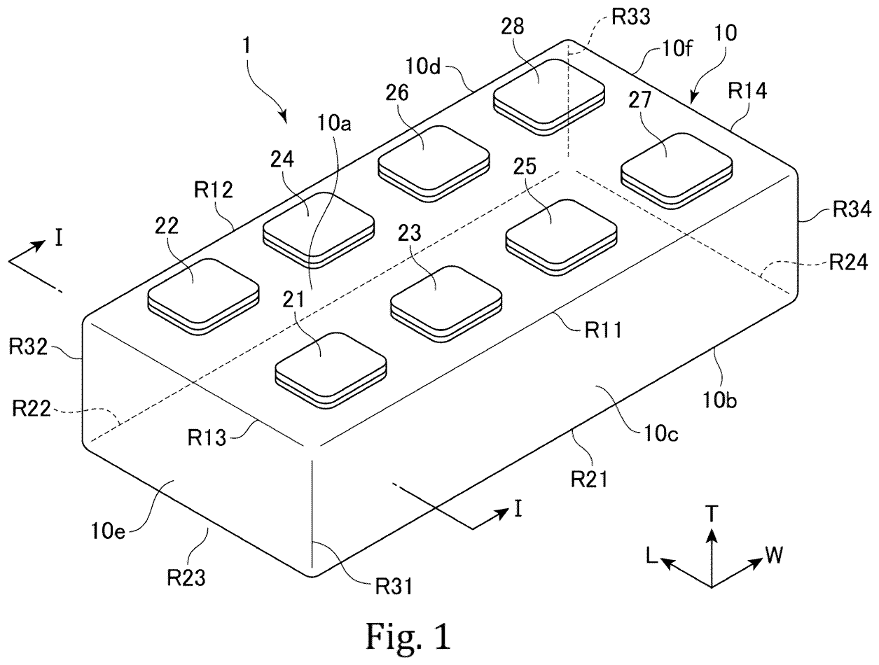

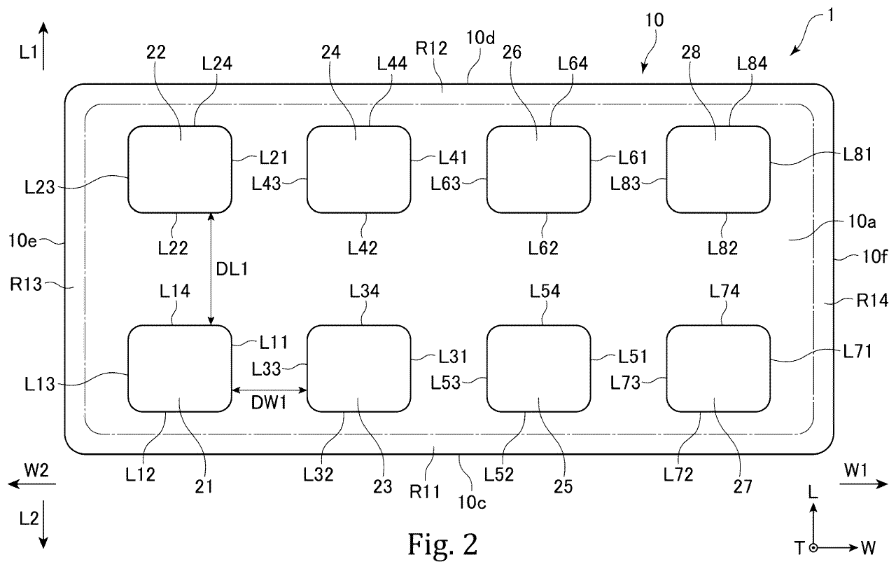

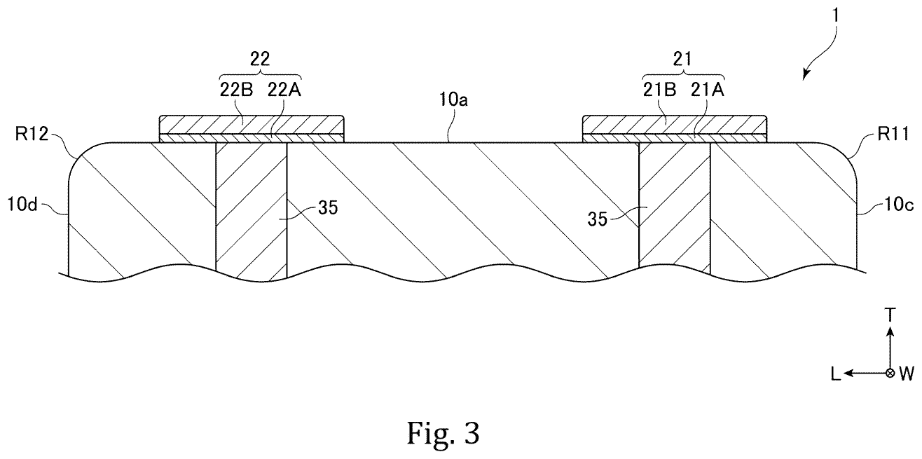

An inductor array 1 according to the first embodiment of the disclosure will now be described with reference to FIGS. 1 to 3. FIG. 1 is a schematic perspective view of the inductor array 1, FIG. 2 is a plan view of the inductor array 1, and FIG. 3 is a schematic sectional view of the inductor array 1 along the I-I line to show an enlarged view of a part of the section.

For convenience of explanation, each of the drawings may show the L axis, the W axis, and the Taxis orthogonal to one another. In this specification, the dimensions, arrangement, shape, and other features of each component of the inductor array 1 may be described with reference to the L, W, and Taxes.

The inductor array 1 may be surface mounted on a substrate. The substrate has land portions. The inductor array 1 is mounted on the substrate by soldering external electrodes and corresponding land portions on the substrate. The substrate having the inductor array 1 mounted thereon can be installed in various electronic devices. The electronic devices in which the substrate with the inductor array 1 can be installed include smartphones, tablets, game consoles, electrical components of automobiles, servers, and various other electronic devices.

In electronic circuits, the inductor array 1 is used to, for example, eliminate noise. The inductor array 1 may be a power inductor built in a power supply line or an inductor used in a signal line. As described below, the inductor array 1 may be embedded in the substrate.

As illustrated, the inductor array 1 includes a base body 10, a plurality of internal conductors provided in the base body 10, and external electrodes provided on the surface of the base body 10. In the illustrated embodiment, the inductor array 1 has eight external electrodes 21, from a first external electrode to an eighth external electrode.

### 1-2. Base Body 10

The base body 10 has an insulating structure. The base body 10 may contain a plurality of metal magnetic particles. The surfaces of the metal magnetic particles are coated with insulating films. Via the surface insulating films, adjacent ones of the metal magnetic particles contained in the base body 10 are bonded to each other. Also, the insulating films electrically insulate the adjacent metal magnetic particles from one another.

The metal magnetic particles contained in the base body 10 are, for example, particles of (1) a metal such as Fe or Ni, (2) a crystalline alloy such as an Fe—Si—Cr alloy, an Fe—Si—Al alloy, or an Fe—Ni alloy, (3) an amorphous alloy such as an Fe—Si—Cr—B—C alloy or an Fe—Si—Cr—B alloy, or (4) a mixture thereof. The composition of the metal magnetic particles contained in the base body 10 is not limited to those described above. For example, the metal magnetic particles contained in the base body 10 may be particles of a Co—Nb—Zr alloy, an Fe—Zr—Cu—B alloy, an Fe—Si—B alloy, an Fe—Co—Zr—Cu—B alloy, an Ni—Si—B alloy, or an Fe—Al—Cr alloy. The Fe-based metal magnetic particles contained in the base body 10 may contain 80 wt % or more Fe. The insulating films formed on the plurality of metal magnetic particles may be an oxide film made of an oxide of the above metals or alloys. The insulating film provided on the surface of each of the metal magnetic particles may be, for example, a silicon oxide film provided by the sol-gel coating process. The average particle size of the metal magnetic particles in the base body 10 is from 1.0 μm to 20 μm. The average particle size of the metal magnetic particles contained in the base body 10 may be smaller than 1. 0 μm or larger than 20 μm. The base body 10 may contain two or more types of metal magnetic particles having different average particle sizes.

The base body 10 may include a resin binding material that binds the metal magnetic particles. The binding material consists of, for example, thermosetting material having a good insulation property. The resin material used for a binding material has a smaller magnetic permeability than the first magnetic material. The resin material used for a binding material may be an epoxy resin, a polyimide resin, a polystyrene (PS) resin, a high-density polyethylene (HDPE) resin, a polyoxymethylene (POM) resin, a polycarbonate (PC) resin, a polyvinylidene fluoride (PVDF) resin, a phenolic resin, a polytetrafluoroethylene (PTFE) resin, or a polybenzoxazole (PBO) resin.

In one embodiment, the base body 10 may be configured to have a rectangular parallelepiped shape. The base body 10 has six surfaces, which are a top surface 10a, a bottom surface 10b, a first end surface 10c, a second end surface 10d, a first side surface 10e, and a second side surface 10f. All the six surfaces are generally flat. In the illustrated embodiment, the top surface 10a corresponds to a “first surface” as described in the claims.

Adjacent ones of the six surfaces forming the base body 10 are connected to each other via a ridge portion. In the illustrated embodiment, the top surface 10a and the first end surface 10c are connected via a ridge R11, the top surface 10a and the second end surface 10d are connected via a ridge R12, the top surface 10a and the first side surface 10e are connected via a ridge R13, the top surface 10a and the second side surface 10f are connected via a ridge R14. The bottom surface 10b and the first end surface 10c are connected via a ridge R21, the bottom surface 10b and the second end surface 10d are connected via a ridge R22, the bottom surface 10b and the first side surface 10e are connected via a ridge R23, and the bottom surface 10b and the second side surface 10f are connected via a ridge R24. Furthermore, the first end surface 10c and the first side surface 10e are connected via a ridge R31, the first side surface 10e and the second end surface 10d are connected via a ridge R32, the second end surface 10d and the second side surface 10f are connected via a ridge R33, the second side surface 10f and the first end surface 10c are connected via a ridge R34. Thus, the outer surface of the base body 10 is defined by the six surfaces (10a to 10f) and 12 ridges (R11 to R14, R21 to R24, and R31 to R34).

Each ridge of the base body 10 has a curved shape. Each ridge of the base body 10 can be formed, for example, by barrel polishing a chip that has been formed into a rectangular shape by dicing into pieces in the manufacturing process of the inductor array 1. Through the barrel polishing, each ridge can be formed to have a desired radius of curvature. The radius of curvature of each ridge is, for example, 20 μm to 100 μm.

### 1-3. Internal Conductor

The inductor array 1 includes the plurality of internal conductors. Each internal conductor is disposed inside the base body 10 such that both ends thereof are exposed from the surface of the base body 10. One end of each internal conductor is electrically connected to one of the external electrodes of the inductor array 1, and the other end of the internal conductor is connected to another one of the external electrodes of the inductor array 1. FIG. 3 shows a internal conductor 35 as an example of the internal conductors provided in the inductor array 1. As illustrated, both ends of the internal conductor 35 are exposed from the top surface 10a of the base body 10 to the outside of the base body 10. One end of the internal conductor 35 is electrically connected to a first external electrode 21, and the other end of the internal conductor 35 is electrically connected to a second external electrode 22. The illustrated inductor array 1 has four internal conductors, including the internal conductor 35. The internal conductors other than the internal conductor 35 are omitted from the drawing. One internal conductor provided in the inductor array 1 is connected to a third external electrode 23 at one end and the other end is connected to a fourth external electrode 24. Another internal conductor provided in the inductor array 1 is connected to a fifth external electrode 25 at one end and to a sixth external electrode 26 at the other end. Yet another internal conductor provided in the inductor array 1 is connected to a seventh external electrode 27 at one end and to an eighth external electrode 28 at the other end.

The internal conductors may be formed in various shapes. Each internal conductor is configured to have a shape that produces a desired inductance. Each internal conductor is wound for a predetermined number of turns around an axis extending, for example, along the T-axis direction. The internal conductor may be formed in a straight line shape, an elliptical shape, a meander shape, and any other shape.

### 1-4. External Electrodes

In the illustrated embodiment, the inductor array 1 has the eight external electrodes. The number of external electrodes provided in the inductor array 1 can be any even number of four or more. For example, the inductor array 1 can have 4, 6, 10, 12, or more even numbers of the external electrodes. Each external electrode is electrically isolated from the other external electrodes.

The illustrated inductor array 1 includes the first external electrode 21, the second external electrode 22, the third external electrode 23, the fourth external electrode 24, the fifth external electrode 25, the sixth external electrode 26, the seventh external electrode 27, and the eighth external electrode 28. All of these eight external electrodes are disposed on the top surface 10a of the base body 10. The first external electrode 21 is situated at the lower left corner in FIG. 2. The second external electrode 22 is spaced apart from the first external electrode 21 in the L1 direction along the L-axis. The third external electrode 23 is spaced apart from the first external electrode 21 in the W1 direction along the W-axis. The fourth external electrode 24 is spaced apart from the third external electrode 23 in the L1 direction along the L-axis. The fifth external electrode 25 is spaced apart from the third external electrode 23 in the W1 direction. The sixth external electrode 26 is spaced apart from the fifth external electrode 25 in the L1 direction. The seventh external electrode 27 is spaced apart from the fifth external electrode 25 in the W1 direction. The eighth external electrode 28 is spaced apart from the seventh external electrode 27 in the L1 direction.

In one embodiment, the external electrodes provided in the inductor array 1 are spaced apart from any of the ridge portions of the base body 10. In the illustrated embodiment, the first external electrode 21, the second external electrode 22, the third external electrode 23, the fourth external electrode 24, the fifth external electrode 25, the sixth external electrode 26, the seventh external electrode 27, and the eighth external electrode 28 provided on the top surface 10a of the base body 10 are spaced apart from any of the ridge portions R11 to R14 surrounding the top surface 10a. In other words, in plan view, the first external electrode 21, second external electrode 22, third external electrode 23, fourth external electrode 24, fifth external electrode 25, sixth external electrode 26, seventh external electrode 27, and eighth external electrode 28 are all disposed so as not to overlap the ridges R11 to R14. For brevity of description, the first external electrode 21, second external electrode 22, third external electrode 23, fourth external electrode 24, fifth external electrode 25, sixth external electrode 26, seventh external electrode 27, and eighth external electrode 28 respectively may be herein simply referred to as “each external electrode”.

The shape of each external electrode provided in the inductor array 1 in plan view will now be described mainly with reference to FIG. 2. Each external electrode has a straight portion extending in a straight line in plan view (i.e., when viewed from the direction along the normal of the top surface 10a or from the T axis). For example, the first external electrode 21 includes straight portions L11, L12, L13, and L14. The straight portions L11 and L13 extend in a direction along the L-axis, and the straight portions L12 and L14 extend in a direction along the W-axis.

The second external electrode 22 includes straight portions L21, L22, L23, and L24. The straight portions L21 and L23 extend in the direction along the L-axis, and the straight portions L22 and L24 extend in the direction along the W-axis. The straight portion L22 of the second external electrode 22 faces the straight portion L14 of the first external electrode 21 in the L-axis direction. The third external electrode 23 includes straight portions L31, L32, L33, and L34. The fourth external electrode 24 includes straight portions L41, L42, L43, and L44. The fifth external electrode 25 includes straight portions L51, L52, L53, and L54. The sixth external electrode 26 includes straight portions L61, L62, L63, and L64. The seventh external electrode 27 includes straight portions L71, L72, L73, and L74. The eighth external electrode 28 includes straight portions L81, L82, L83, and L84.

In each external electrode, each straight portion may be connected to the adjacent straight portion via a curved corner portion. For example, in the example of FIG. 2, the straight portion L11 and straight portion L12 are connected by a curved corner portion. Similarly, the straight portion L12 and straight portion L13, the straight portion L13 and straight portion L14, and the straight portion L14 and straight portion L11 are connected by curved corner portions, respectively. Thus, the profile of the first external electrode 21 has an oval shape with these straight portions L11, L12, L13, L14 and curved corners connecting between the adjacent straight portions. In the second eternal electrode 22, the straight portion L21 and straight portion L22, the straight portion L22 and straight portion L23, and the straight portion L24 and straight portion L21 are connected by curved corner portions, respectively. Thus, the profile of the second external electrode 22 is an oval shape with these straight portions L21, L22, L23, L24 and curved corners connecting between the adjacent straight portions.

The third external electrode 23, fourth external electrode 24, fifth external electrode 25, sixth external electrode 26, seventh external electrode 27, and eighth external electrode 28 each present the same shape as the first external electrode 21 in plan view. That is, the second external electrode 22, third external electrode 23, fourth external electrode 24, fifth external electrode 25, sixth external electrode 26, seventh external electrode 27, and eighth external electrode 28 each present an oval shape in plan view.

The first external electrode 21, second external electrode 22, third external electrode 23, fourth external electrode 24, fifth external electrode 25, sixth external electrode 26, seventh external electrode 27, and eighth external electrode 28 each have a shape with rounded corners in plan view. Oval is an example of the shape with rounded corners. Each external electrode may be configured to present a shape of an ellipse in addition to the oval.

In the inductor array 1, the external electrodes may be arranged so that the distance between the external electrode connected to one internal conductor and the external electrode connected to another internal conductor other than said one internal conductor is smaller than the distance between the external electrode connected to one end of said one internal conductor and the external electrode connected to the other end of said one internal conductor. In the embodiment of FIG. 2, the external electrodes that are adjacent in the W-axis direction are connected to different internal conductors. The spacing between the adjacent external electrodes in the W-axis direction may be smaller than the spacing between the adjacent external electrodes in the L-axis direction. For example, a distance DW1 between the first external electrode 21 connected to one end of the internal conductor 35 and the third external electrode 23 connected to one end of a different internal conductor from the internal conductor 35 may be smaller than a distance DL1 between the first external electrode 21 and the second external electrode 22 connected to the other end of the internal conductor 35. In the inductor array 1, the internal conductors are aligned along the W-axis direction, so that as the number of the internal conductors increases, the dimension of the inductor array 1 in the W-axis direction increases. By making the distance DW1 smaller than the distance DL1, the dimension of the inductor array 1 in the W-axis direction can be made compact.

The first external electrode 21 includes a first base electrode layer 21A and a first plating layer 21B covering the first base electrode layer 21A. The second external electrode 22 includes a second base electrode layer 22A and a second plating layer 22B covering the second base electrode layer 22A. Each external electrode other than the first external electrode 21 and the second external electrode 22 also includes the base electrode layer and the plating layer covering the base electrode layer in the same manner as the first external electrode 21 and the second external electrode 22.

The first base electrode layer 21A and the second base electrode layer 22A each be formed by, for example, applying a paste-like electrically conductive material to the surfaces of the insulator body 10 and curing the electrically conductive material thus applied. As an electrically conductive material for the first base electrode layer 21A and the second base electrode layer 22A, there can be used, for example, a metal material such as copper (Cu), nickel (Ni), silver (Ag), palladium (Pd), gold (Au), or the like or an alloy material including one or more of these metal materials. Examples of an alloy material mentioned here may include a Cu—Ni alloy.

The first plating layer 21B is formed on the surface of the first base electrode layer 21A to cover the first base electrode layer 21A. The first plating layer 21B is formed, for example, by an electrolytic plating method. When the first plating layer 21B is formed by the electrolytic plating method, the first plating layer 21B extends along the conductive first base electrode layer 21A to the edge of the first base electrode layer 21A. Therefore, when the inductor array 1 is viewed in plan (in other words, when viewed from the direction normal to the top surface 10a (in the illustrated embodiment, direction along the T-axis), the shape of the first plating layer 21B is same as or similar to that of the first base electrode layer 21A. At least one of the first plating layer 21B or the second plating layer 22B may have a two-layer structure. In a case where the first plating layer 21B has the two-layer structure, the first plating layer contacting the first base electrode layer may be a nickel plating layer and the second plating layer formed on the first plating layer may be a tin plating layer. In a case where the second plating layer 22B has the two-layer structure, the first plating layer contacting the second base electrode layer 22A may be a nickel plating layer and the second plating layer formed on the first plating layer may be a tin plating layer.

The second plating layer 22B is formed on the surface of the second base electrode layer 22A to cover the second base electrode base layer 22A. Each of the external electrodes, which are the third external electrode 23 to eighth external electrode 28, has a plating layer that covers the surface of the respective base electrode layer. The description regarding the first plating layer 21B also applies to the second plating layer 22B of the second external electrode 22 and the plating layers of the third through eighth external electrodes 23 through 28.

Each external electrode is designed and fabricated to have an area larger than a predetermined area to ensure bonding strength with the internal conductor and to lower electrical resistance. In the embodiment of FIG. 2, the straight portion L14 of the first external electrode 21 and the straight portion L22 of the second external electrode 22 are disposed to face each other in the L-axis direction, so that the spacing between the first external electrode 21 and the second external electrode 22 can be made larger compared to the cases where the first and second external electrodes 21 and 22 are formed circular in plan view or the first and second external electrodes 21 and 22 are formed to have curved surfaces protruding toward each other. This configuration can reduce the occurrence of a short circuit between the first external electrode 21 and the second external electrode 22. In the embodiment of FIG. 2, the straight portion L11 of the first external electrode 21 and the straight portion L33 of the third external electrode 23 are disposed to face each other in the W-axis direction, so that the spacing between the first external electrode 21 and the third external electrode 23 can be made larger compared to the cases where the first and third external electrodes 21 and 23 are formed circular in plan view or the first and third external electrodes 21 and 23 are formed to have curved surfaces protruding toward each other.

### 1-5. Manufacturing Method

The inductor array 1 is fabricated, for example, by sheet lamination, printed lamination, thin film process, slurry build, and other known manufacturing methods. In these manufacturing methods, as known to those skilled in the art, a structure containing precursors of the inductor arrays 1 is fabricated and this structure is then cut into pieces using a cutting machine such as a dicing machine or laser cutting machine. The ridges of the base body 10 are formed by barrel polishing or other polishing process on these individualized chips.

### 1-6. Interim Summary

When forming the plating layer of each external electrode by the electrolytic plating method, a stronger electric field is generated in each ridge portion of the base body 10 than in other areas (each surface), and plating elongation is likely to occur in the ridge portions of the base body 10. If plating elongation occurs at the ridge portions of the base body 10, the insulation reliability between the external electrodes disposed adjacent to each other along the ridge portions will deteriorate. To address this, in the inductor array 1 of the first embodiment of the disclosure, the external electrodes on the top surface 10a of the base body 10 are spaced apart from any of the ridge portions R11 to R14 surrounding the top surface 10a. For example, the first external electrode 21 on the top surface 10a of the base body 10 is spaced apart from the ridge portion R11 (and from the other ridge portions R12 to R14), which prevents the plating elongation along the ridge portion R11 when the first plating layer 21B of the first external electrode 21 is formed. As a result, excessive growth of the first plating layer 21B in the W-axis direction along the ridge R11 can be suppressed, and thus the insulation reliability between the first external electrode 21 and the third external electrode 23 can be secured. By the same mechanism, insulation reliability is also ensured between other adjacent external electrodes in the W-axis direction, namely between the third external electrode 23 and the fifth external electrode 25, between the fifth external electrode 25 and the seventh external electrode 27, between the second external electrode 22 and the fourth external electrode 24, between the fourth external electrode 24 and the sixth external electrode 26, and between the sixth external electrode 2 6 and the eighth external electrode 28, and between the sixth external electrode 2 6 and the eighth external electrode 28.

The base body 10 made of metallic magnetic particles is less insulating than a base body made of ferrite, and therefore, plating elongation on the surface is more likely to occur than on the surface of the base body made of ferrite. In the inductor array 1, each external electrode on the top surface 10a of the base body 10 is spaced apart from any of the ridges R11 to R14 surrounding the top surface 10a, thus suppressing the plating elongation and ensuring the insulation reliability between the external electrodes even when the base body 10 is made of metallic magnetic particles.

Since a plurality of elements are arranged along the W-axis direction in the inductor array 1, as the number of elements built into the base body 10 increases, there may be more demands for compactness in the W-axis direction. In this respect, the insulation reliability between adjacent external electrodes in the W-axis direction is improved in the inductor arrayl, the spacing between the adjacent external electrodes in the W-axis direction can be made smaller than the spacing between the adjacent external electrodes in the L-axis direction. This allows the dimension of the inductor array 1 in the W-axis direction to be made more compact.

In the inductor array 1, each external electrode has a shape with rounded corners in plan view, and thus, when forming the plating layers (e.g., the first plating layer 21B and the second plating layer 22B) of each external electrode, it is possible to prevent a strong electric field to be formed in some regions on the base electrode layer. Therefore, it is possible to suppress the excessive growth of plating in the some regions on the base electrode layer than in other areas. Therefore, the plating layer of each external electrode provided in the inductor array 1 is formed to have a more uniform thickness compared to the surface of conventional external electrodes having angular shapes in plan view. Consequently, when surface mounting the inductor array 1 on a substrate, the inductor array 1 can be held in a stable position on the substrate.

### 2. Second Embodiment (Inductor Array 101)

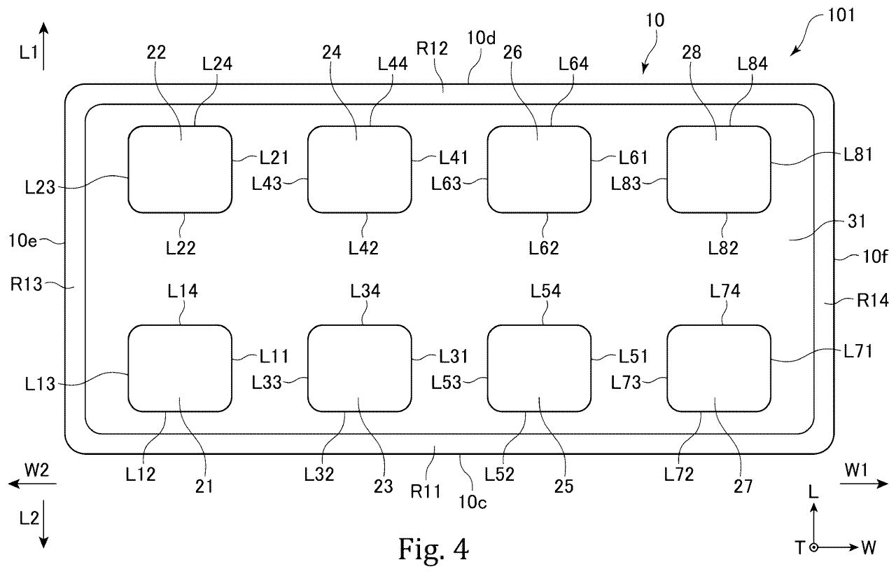

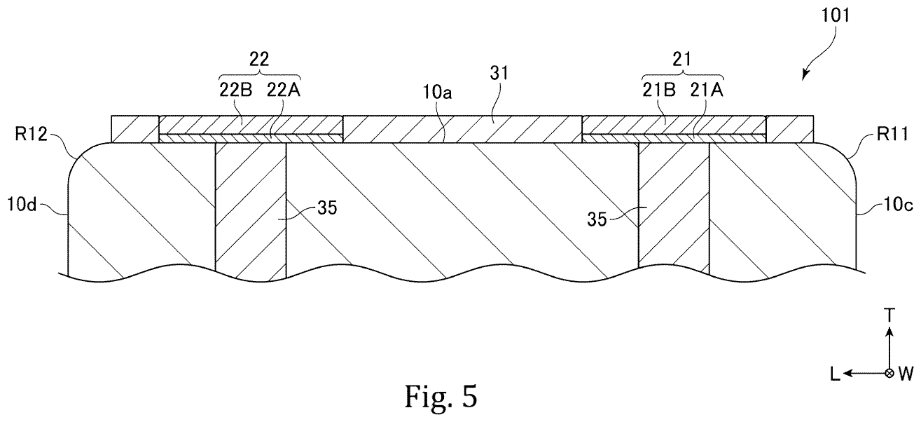

An inductor array 101 according to the second embodiment of the disclosure will be now described with reference to FIG. 4 and FIG. 5. The inductor array 101 is different from the inductor array 1 in that it includes an insulating film 31. FIG. 4 is a plan view of the inductor array 101 of the second embodiment, and FIG. 5 is a sectional view of the inductor array 101 cut in a plane that is parallel to the LT plane and passes through the first and second external electrodes 21 and 22. In the following, the insulating film 31 provided in the inductor array 101 will be mainly described, and description about components of the inductor array 101 that are common with the inductor array 1 will be omitted.

The inductor array 101 has an insulating film 31 provided on the top surface 10a of the base body 10. The insulating film 31 is provided to cover an area of the top surface 10a of the base body 10 where no external electrodes are provided. Thus, the insulating film 31 is arranged on the top surface 10a of the base body 10 so as to surround the periphery of each of the first external electrode 21 to the eighth external electrode 28. The insulating film 31 is made of an insulating material having an excellent insulation property. The insulating film 31 has a higher electric resistivity than the base body 10. The insulating film 31 may be made of, for example, resin materials such as silicon resin, epoxy resin, and phenol resin, glass such as borosilicate glass, and metal oxides such as Al oxide.

Since the insulating film 31 is provided across the adjacent external electrodes, the insulating film 31 further improves the insulation reliability between the adjacent external electrodes. For example, as shown in FIG. 5, the insulating film 31 extends between the first external electrode 21 and the second external electrode 22 disposed adjacent to the first external electrode 21 in the L-axis direction. This allows the insulating film 31 to improve the insulation reliability between the first external electrode 21 and the second external electrode 22.

The insulating film 31 is also provided between the external electrodes and the respective ridge portions on the top surface 10a of the base body 10. For example, a part of the insulating film 31 is disposed between the first external electrode 21, third external electrode 23, fifth external electrode 25, and seventh external electrode 27, and the ridge portion R11. Another part of the insulating film 31 is disposed between the second external electrode 22, the fourth external electrode 24, the sixth external electrode 26, and the seventh external electrode 28, and the ridge portion R12. The insulating film 31 may be provided to cover each ridge portion. This may further suppress plating elongation at the ridge portions covered with the insulating film 31. For example, the insulating film 31 may cover the ridge portion R11 to further suppress plating elongation at the ridge portion R11.

In one embodiment of the disclosure, in the base body 10, the surface roughness of the top surface 10a is smaller than the surface roughness of the first end surface 10c, second end surface 10d, first side surface 10e, and second side surface 10f. By reducing the surface roughness of the top surface 10a, the insulating film 31 provided on the top surface 10a, which is necessary to ensure insulation between the external electrodes, can be made thinner. The surface roughness of the base body 10 can be expressed in terms of arithmetic surface roughness Sa calculated by using a measuring instrument in conformity to ISO 25178. The arithmetic surface roughness Sa can be measured using a commercially available instrument that can measure the arithmetic surface roughness Sa, such as a shape analysis laser microscope (VK-X250) manufactured by Keyence Corporation.

### 3. Third Embodiment (Inductor Array 201)

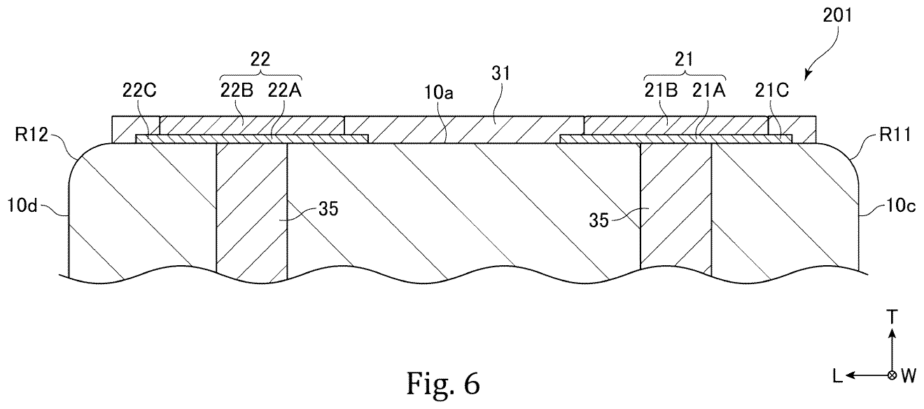

An inductor array 201 according to the third embodiment of the disclosure will be now described with reference to FIG. 6. The inductor array 201 is different from the inductor array 101 in that the insulating film 31 covers a part of the base electrode layer. FIG. 6 is a sectional view of the inductor array 201 cut in a plane that is parallel to the LT plane and passes through the first and second external electrodes 21 and 22. In the following, description will be given for elements of the inductor array 201 that differ from the inductor array 101, and description about components of the inductor array 201 that are common with the inductor array 101 will be omitted.

The insulating film 31 provided in the inductor array 201 covers a part of the top surface of each of the first and second base electrode layers 21A and 22A, as shown in FIG. 6. The insulating film 31 covers a ring-shaped area along a periphery 21C of the first base electrode layer 21A and a ring-shaped area along a periphery 22C of the top surface of the second base electrode layer 22A. Although not shown in the drawing, the respective base electrode layers provided in the external electrodes other than the first external electrode 21 and the second external electrode 22 may also be partially covered on their top surfaces (periphery) by the insulating film 31.

According to the embodiment of FIG. 6, the top surface 10a of the base body 10 is covered with the insulating film 31, the first base electrode layer 21A, and the second base electrode layer 22A, so the top surface 10a of the base body 10 is not exposed at the time when the first plating layer 21B and the second plating layer 22B are formed. Therefore, when forming the first plating layer 21B and the second plating layer 22B by plating process, moisture can be prevented from penetrating into the interior of the base body 10. For example, a cleaning solution and plating solution used in the plating process can be prevented from penetrating into the interior of the base body 10.

In the inductor array 201, the periphery of the top surface of the base electrode layer of each external electrode is covered with the insulating film 31 to prevent the plating from extending outside of the top surface of each base electrode layer when the plating layer is formed on the top surface of each base electrode layer. This further improves the insulation reliability between the adjacent external electrodes in the inductor array 201.

### 4. Fourth Embodiment (Inductor Array 301)

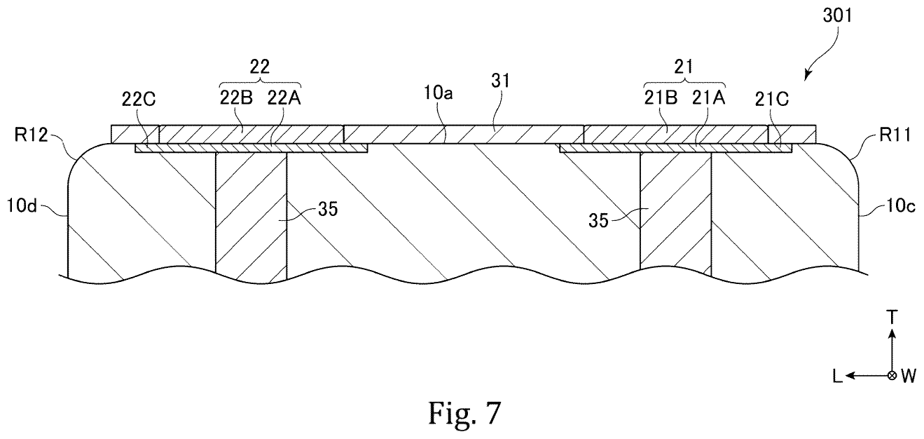

An inductor array 301 of the third embodiment of the disclosure will be now described with reference to FIG. 7. The inductor array 301 is different from the inductor array 201 in that the base electrode layer is embedded in the base body 10. FIG. 7 is a sectional view of the inductor array 301 cut in a plane that is parallel to the LT plane and passes through the first and second external electrodes 21 and 22. In the following, description will be given for elements of the inductor array 301 that differ from the inductor array 201, and description about components of the inductor array 301 that are common with the inductor array 201 will be omitted.

In the inductor array 301, the base electrode layer of each external electrode is embedded in the base body 10 such that only its top surface is exposed. A plating layer is then provided on the top surface of the base electrode layer exposed from the base body 10. For example, as shown in FIG. 7, the first base electrode layer 21A of the first external electrode 21 and the second base electrode layer 22A of the second external electrode 22 are both embedded in the base body 10. The first plating layer 21B is provided on the top surface of the first base electrode layer 21A that is exposed from the base body 10 and the insulating film 31. The second plating layer 22B is provided on the top surface of the second base electrode layer 22A that is exposed from the base body 10 and the insulating film 31. For each of the other external electrodes, the respective base electrode layer is embedded in the base body 10, and the plating layer is provided on the top surface of the base electrode layer.

The dimension of the inductor array 301 in the T-axis direction can be made more compact.

### 5. Fifth Embodiment (Inductor Array 301)

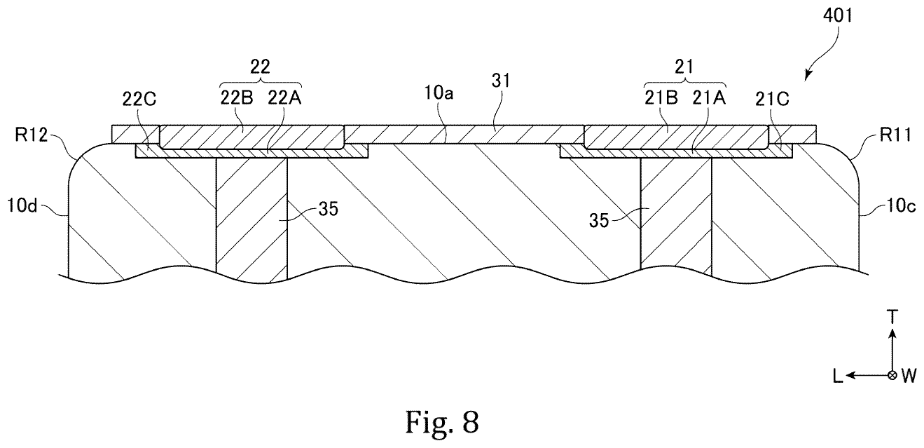

An inductor array 401 of the fifth embodiment of the disclosure will be now described with reference to FIG. 8. The inductor array 401 is different from the inductor array 301 in the shape of the base electrode layer. FIG. 8 is a sectional view of the inductor array 401 cut in a plane that is parallel to the LT plane and passes through the first and second external electrodes 21 and 22. In the following, description will be given for elements of the inductor array 401 that differ from the inductor array 301, and description about components of the inductor array 401 that are common with the inductor array 301 will be omitted.

In the inductor array 401, the first base electrode layer 21A is configured such that the top surface of its periphery 21C is flush with the top surface 10a of the base body 10 or recessed from the top surface 10a of the base body 10 toward the inside of the base body 10. The first base electrode layer 21A has an inner region that is surrounded by its periphery 21C and recessed from the periphery 21C toward the inside of the base body 10. The second base electrode layer 22A is configured such that the top surface of the periphery 22C is flush with the top surface 10a of the base body 10 or is recessed from the top surface 10a of the base body 10 toward the inside of the base body 10. The second base electrode layer 22A has an inner region that is surrounded by its periphery 22C and recessed from the periphery 22C toward the inside of the base body 10. The depth of the recessed inner region of the first base electrode layer 21A and the recessed inner region of the second base electrode layer 22A may be smaller than one-half the thickness of the insulating film 31.

The dimension of the inductor array 401 in the T-axis direction can be made more compact. It is also possible to prevent the portion of the insulating film 31 that covers the periphery 21C of the first base electrode layer 21A and the periphery 22C of the second base electrode layer 22A from protruding outward more than the other portions.

### 6. Manufacturing Method of Inductor Built-in Substrate

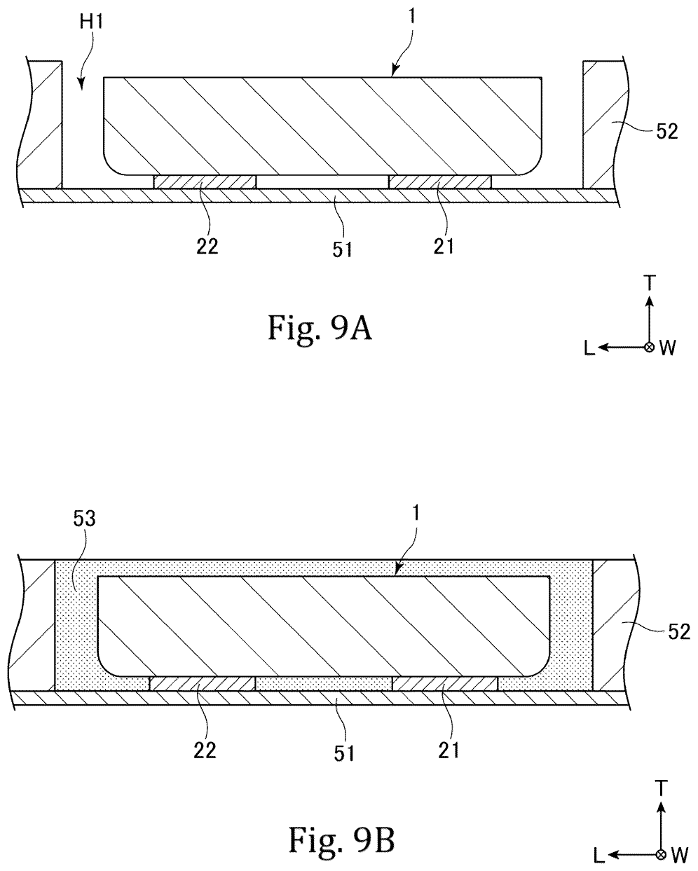

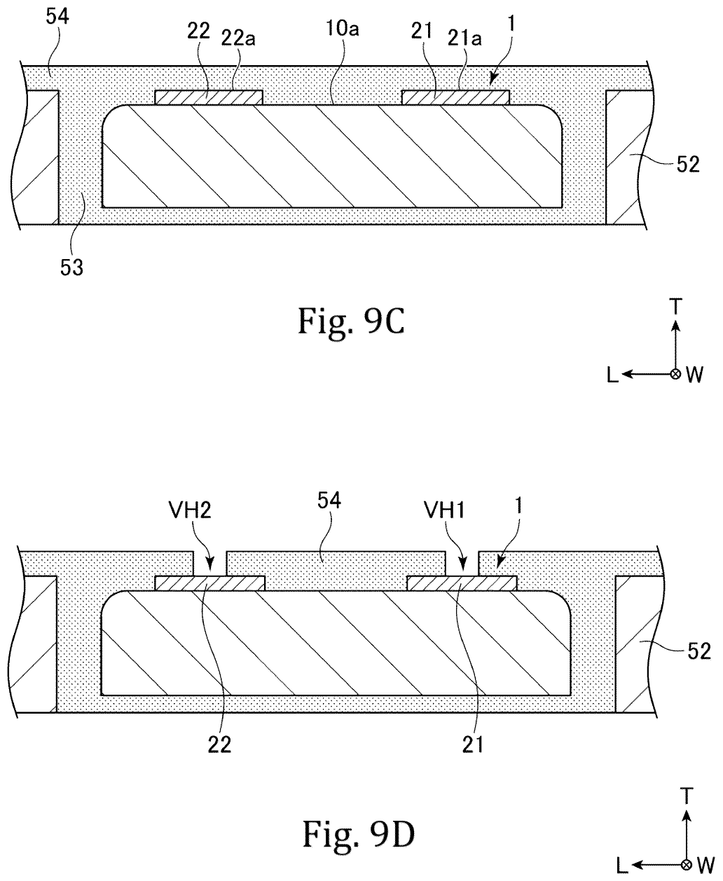

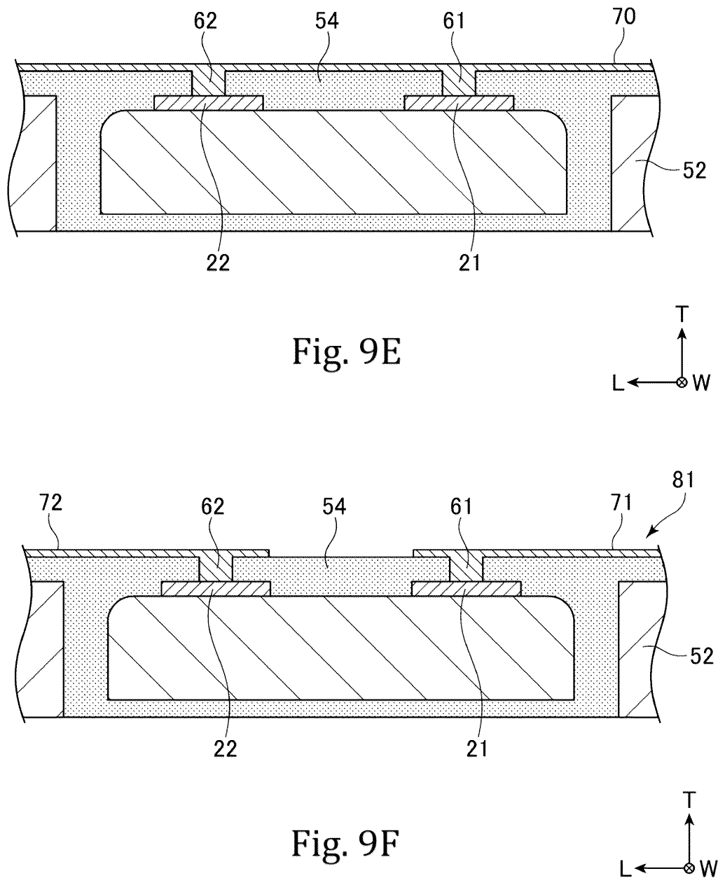

One example of a method of manufacturing the inductor built-in substrate including the inductor array 1 therein will now be described with reference to FIGS. 9A to 9F.

First, as shown in FIG. 9A, an insulating layer 52 is formed on top of a film 51, and a cavity H1 is formed in the insulating layer 52. Then, the inductor array 1 is disposed in the cavity H1 so that the first and second external electrodes 21 and 22 are in contact with the film 51. The film 51 is a film for tentatively mounting the inductor array 1 in the manufacturing process of the inductor built-in substrate. The insulating layer 52 is a part of a multilayer printed circuit board. Although it is not shown in the drawing, multiple wiring patterns and via conductors connecting the wiring patterns may be formed in the insulating layer 52. The insulating layer 52 is made of an insulating material such as glass epoxy. The material of the insulating layer 52 is not limited to glass epoxy and can be various materials suitable for the insulating layer of the multilayer printed circuit board.

Next, as shown in FIG. 9B, a first resin layer 53 is formed to cover the inductor array 1 in the cavity H1 in which the inductor array 1 is disposed. The first resin layer 53 is made of, for example, a thermosetting resin. The first resin layer 53 may be formed by injecting uncured thermosetting resin into the cavity H1 and then heating and curing the injected thermosetting resin. In this way, an intermediate body in which the inductor array 1 is sealed by the first resin layer 53 in the cavity H1 has been fabricated.

Next, as shown in FIG. 9C, the intermediate body is flipped upside down, the film 51 is removed, and a second resin layer 54 is formed on the top surface of the intermediate body from which the film 51 has been removed. The second resin layer 54 may be formed of the same thermosetting resin as the first resin layer 53. The second resin layer 54 is formed to cover the first external electrode 21 and the second external electrode 22 that are exposed when the film 51 is removed.

Next, as shown in FIG. 9D, a first via hole VH1 and a second via hole VH2 are formed in the second resin layer 54 to expose a part of the first external electrode 21 and the second external electrode 22. The first via hole VH1 is formed by irradiating the first external electrode 21 with a laser from the upper side in the drawing. Similarly, the second via hole VH2 is formed by irradiating the second external electrode 22 with a laser from the upper side in the drawing. The laser used is, for example, a carbon dioxide gas laser. By using two carbon dioxide gas laser machines, the laser can be simultaneously irradiated toward the top surface 21a of the first external electrode 21 and the top surface 22a of the second external electrode 22, so the first via hole VH1 and the second via hole VH2 can be formed in simultaneously. This allows for shorter manufacturing time.

Since the first external electrode 21 and the second external electrode 22 present a rounded shape in plan view as described above, the top surface 21a and the top surface 22a, respectively, are smoother than conventional external electrodes. Thus, the diffuse reflection of the laser beams irradiated toward the first and second external electrodes 21 and 22 to form the first and second via holes VH1 and VH2, respectively, is suppressed on the top surfaces 21a and 22a, so that the first and second via holes VH1 and VH2 can be formed with high accuracy.

Next, as shown in FIG. 9E, a via conductor 61 is formed in the first via hole VH1 and a via conductor 62 is formed in the second via hole VH2 by plating the bottom and wall surfaces defining the first via hole VH1 and the second via hole VH2. Also, by applying a plating process to the surface of the second resin layer 54, a conductor layer 70 is formed on the surface of the second resin layer 54.

Next, as shown in FIG. 9F, by etching a region of the conductor layer 70 between the first external electrode 21 and the second external electrode 22 in the L-axis direction, a first wiring pattern 71 connected to the first external electrode 21 and a second wiring pattern 72 connected to the second external electrode 22 are formed.

The above process produces an inductor built-in substrate 81 with the inductor array 1 embedded therein.

In addition to the inductor array 1 shown in the figures, various electronic components may be built into the inductor built-in substrate 81. The electronic components other than the inductor array 1 built into the inductor built-in substrate 81 may be passive elements such as inductors, capacitors, resistors, etc., or active elements such as semiconductor ICs.

The inductor built-in substrate 81 can be installed in various electronic devices. The electronic devices in which the inductor built-in substrate 81 can be installed include smartphones, tablets, game consoles, electrical components of automobiles, servers, and various other electronic devices.

### 7. Notes

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” and “third” used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

The expression of “including” a constituent element used herein does not exclude other constituent elements but rather means that other constituent elements can be further included, as long as they are consistent with the invention.

### 8. Additional Embodiments

Embodiments disclosed herein also include the following.

### Additional Embodiment 1

An inductor array including:
a base body (10) containing a plurality of metal magnetic particles and having a first surface (10a), a second surface (10c) connected to the first surface via a first ridge portion (R11), and a third surface (10d) facing the second surface in a first direction (L) and connected to the first surface via a second ridge portion (R12);
a first internal conductor (25) provided inside the base body;
a second internal conductor provided inside the base body;
a first external electrode (21) provided on the first surface of the base body, the first external electrode being connected to one end of the first internal conductor;
a second external electrode (22) provided on the first surface of the base body spaced apart from the first external electrode in the first direction, the second external electrode being connected to the other end of the first internal conductor;
a third external electrode (23) provided on the first surface of the base body spaced apart from the first external electrode in a second direction orthogonal to the first direction, the third external electrode being connected to one end of the second internal conductor;
a fourth external electrode (24) provided on the first surface of the base body spaced apart from the third external electrode in the first direction, the fourth external electrode being connected to the other end of the second internal conductor; and
wherein the first external electrode, the second external electrode, the third external electrode, and the fourth external electrode on the first surface are all spaced apart from both the first ridge portion and the second ridge portion.

### Additional Embodiment 2

The inductor array of Additional Embodiment 1, wherein when viewed from a normal direction of the first surface, the profile of the first external electrode has a first straight portion (L12) extending along the second direction (W).

### Additional Embodiment 3

The inductor array of Additional Embodiment 2, wherein when viewed from the normal direction of the first surface, the profile of the second external electrode has a second straight portion (L22) that extends along the second direction and faces the first straight portion in the first direction.

### Additional Embodiment 4

The inductor array of any one of Additional Embodiments 1 to 3, wherein the first external electrode includes a first base electrode layer (21A) and a first plating layer (21B) provided on the first base electrode layer.

### Additional Embodiment 5

The inductor array of Additional Embodiment 4, wherein the first base electrode layer is embedded in the base body.

### Additional Embodiment 6

The inductor array of Additional Embodiment 5, wherein the first base electrode layer is embedded in the base body such that only its top surface is exposed.

### Additional Embodiment 7

The inductor array of any one of Additional Embodiments 4 to 6, wherein the first base electrode layer has a periphery (21C) and an inner region surrounded by the periphery when viewed from a normal direction of the first surface, and wherein the inner region is recessed from the periphery toward the inside of the base body.

### Additional Embodiment 8

The inductor array of any one of Additional Embodiments 1 to 7, further including an insulating film provided on the first surface of the base body so as to surround the periphery of each of the first to forth external electrodes.

### Additional Embodiment 9

The inductor array of Additional Embodiment 8, wherein the insulating film (31) is provided on the first surface of the base body to cover the periphery (21C) of the base electrode layer.

### Additional Embodiment 10

The inductor array of any one of Additional Embodiments 1 to 9, wherein when viewed from the second direction, both the first and second ridge portions are curved.

### Additional Embodiment 11

The inductor array of any one of Additional Embodiments 1 to 10, wherein the second external electrode includes a second base electrode layer (22A) and a second plating layer (22B) provided on the second base electrode layer.

### Additional Embodiment 12

The inductor array of any one of Additional Embodiments 1 to 11, wherein the first plating layer and the second plating layer are formed by an electrolytic plating method.

### Additional Embodiment 13

An inductor built-in substrate including the inductor array of any one of Additional Embodiments 1 to 12.

What is claimed is:

1. An inductor array, comprising:
a base body containing a plurality of metal magnetic particles, the base body having a first surface, a second surface connected to the first surface via a first ridge portion, and a third surface facing the second surface in a first direction and connected to the first surface via a second ridge portion;
a first internal conductor provided inside the base body;
a second internal conductor provided inside the base body;
a first external electrode provided on the first surface of the base body, the first external electrode being connected to one end of the first internal conductor;
a second external electrode provided on the first surface of the base body spaced apart from the first external electrode in the first direction, the second external electrode being connected to the other end of the first internal conductor;
a third external electrode provided on the first surface of the base body spaced apart from the first external electrode in a second direction orthogonal to the first direction, the third external electrode being connected to one end of the second internal conductor;
a fourth external electrode provided on the first surface of the base body spaced apart from the third external electrode in the first direction, the fourth external electrode being connected to the other end of the second internal conductor; and
wherein the first external electrode, the second external electrode, the third external electrode, and the fourth external electrode on the first surface are all spaced apart from both the first ridge portion and the second ridge portion.

2. The inductor array of claim 1, wherein when viewed from a normal direction of the first surface, a profile of the first external electrode has a first straight portion extending along the second direction.

3. The inductor array of claim 2, wherein when viewed from the normal direction of the first surface, a profile of the second external electrode has a second straight portion that extends along the second direction and faces the first straight portion in the first direction.

4. The inductor array of claim 1, wherein the first external electrode includes a first base electrode layer and a first plating layer provided on a top surface of the first base electrode layer.

5. The inductor array of claim 4, wherein the first base electrode layer is embedded in the base body.

6. The inductor array of claim 5, wherein the first base electrode layer is embedded in the base body such that only its top surface is exposed.

7. The inductor array of claim 4, wherein the first base electrode layer has a periphery and an inner region surrounded by the periphery when viewed from a normal direction of the first surface, and
wherein the inner region is recessed from the periphery toward the inside of the base body.

8. The inductor array of claim 1, further comprising an insulating film provided on the first surface of the base body so as to surround the periphery of each of the first to forth external electrodes.

9. The inductor array of claim 8, wherein the insulating film is provided on the first surface of the base body to cover a periphery of the base electrode layer.

10. The inductor array of claim 1, wherein when viewed from the second direction, both the first and second ridge portions are curved.

11. The inductor array of claim 4, wherein the second external electrode includes a second base electrode layer and a second plating layer provided on the second base electrode layer.

12. The inductor array of claim 11, wherein the first plating layer and the second plating layer are formed by an electrolytic plating method.

13. The inductor array of claim 1, wherein a part of the first internal conductor is exposed outside the base body.

14. An inductor built-in substrate comprising the inductor array of claim 1.
